(19) United States
(12) Patent Application Publication
(10) Pub. No.: US 2017/0010056 A1
(43) Pub. Date: Jan. 12, 2017

(54) HEAT EXCHANGER

(71) Applicant: MAHLE INTERNATIONAL GMBH, Stuttgart (DE)

(72) Inventors: Oliver LIEDTKE, Waibstadt (DE); Matthias MAGDALINSKI, Besigheim (DE)

(73) Assignee: MAHLE INTERNATIONAL GMBH, Stuttgart (DE)

(21) Appl. No.: 15/113,483

(22) PCT Filed: Jan. 23, 2015
(86) PCT No.: PCT/EP2015/051364

§ 371 Date: Jul. 22, 2016

(30) Foreign Application Priority Data
Jan. 23, 2014 (DE) 10 2014 201 264.3

(51) Int. Cl. F28F 9/02; F28D 1/053; F02B 29/04; F28D 1/04

(52) U.S. Cl. CPC F28F 9/0224; F28D 1/0435; F28F 9/0202; F28F 9/0253; F28D 1/05375; F02B 29/045; F28D 2021/0082

(57) ABSTRACT

The invention relates to a heat exchanger, in particular for a motor vehicle, having a first coolant circuit which has multiple first tubes and having a second coolant circuit which has multiple second tubes, having a plate, wherein the plate has a bead, wherein the plate has a first plate region with openings for receiving the first tubes and a second plate region with openings for receiving the second tubes, having a cover which is connected to the plate, wherein the cover has a first collecting tank and a second collecting tank, wherein the first collecting tank is connected in fluid-tight fashion to the first plate region and the second collecting tank is connected in fluid-tight fashion to the second plate region, wherein the cover has, between the first and the second collecting tank, an opening for receiving the bead.

### TECHNICAL FIELD

The invention relates to a heat exchanger, in particular in a motor vehicle, in particular a heat exchanger for cooling charge air for an internal combustion engine in the motor vehicle.

### PRIOR ART

In a motor vehicle, a heat exchanger may be used, in an intake tract of a supercharged internal combustion engine, as a charge-air cooler (CAC). The charge-air cooler is typically arranged between a compressor, in particular a compressor wheel of a turbocharger or supercharging blower, in an intake tract of the internal combustion engine and an inlet valve and serves for dissipating some of the heat that can be generated in a turbocharger as a result of the compression of the air. In this way, the power and the efficiency of the internal combustion engine can be increased.

A multistage, sequential charge-air cooler, also referred to as an indirect charge-air cooler (iCAC), will typically be arranged in a close-coupled position between the compressor and a throttle flap and operate as an air/coolant cooler. This is typically realized in that heat is extracted. from the charge air and the charge air can consequently be cooled. In a compact embodiment, the indirect charge-air cooler (iCAC) has two mutually independent, separate coolant circuits, wherein the air is recooled in a low-temperature cooler of a low-temperature circuit. Known indirect charge-air coolers typically have a fin-tube system.

DE 10 2010 063 324 A1 discloses a device for cooling charge air for an internal combustion engine of a vehicle. The device comprises a multiplicity of first coolant tubes for conducting a first coolant and a multiplicity of second coolant tubes for conducting a second coolant, wherein the first coolant tubes and the second coolant tubes extend along a direction of longitudinal extent of the device, and the multiplicity of first coolant tubes is arranged adjacent to the multiplicity of second coolant tubes in a direction of transverse extent of the device. The end-side collecting tanks are in this case each formed by a common plate and common collecting tank covers, in which there are provided partitions for dividing purposes.

### Presentation of the Invention, Problem, Solution, Advantages

It is the object of the invention to provide a heat exchanger which has an improved construction and is easy to produce.

This is achieved by way of a heat exchanger having the features of claim 1.

In an exemplary embodiment of the heat exchanger, in particular for a motor vehicle, having a first coolant circuit which has multiple first tubes, and having a second coolant circuit which has multiple second tubes, having a plate, wherein the plate has a bead, and wherein the plate has a first plate region with openings for receiving the first tubes and a second plate region with openings for receiving the second tubes, having a cover which is connected to the plate, wherein the cover has a first collecting tank and a second collecting tank, wherein the first collecting tank is connected in fluid-tight fashion to the first plate region and the second collecting tank is connected in fluid-tight fashion to the second plate region, wherein the cover has, between the first and the second collecting tank, an opening for receiving the bead. The bead is preferably a channel-like depression which is stamped into the plate. The plate may thus have a stamped plate portion.

The first tubes and the second tubes are preferably coolant tubes through which a coolant can flow. The tubes are preferably in the form of flat tubes. Here, the first collecting tank is preferably arranged substantially parallel to the first plate region, and the second collecting tank is preferably arranged substantially parallel to second plate region of the plate of the heat exchanger. A collecting tank side wall of the first and/or second collecting tank is arranged substantially perpendicular to the plate.

The opening is preferably punched out of the cover. The punched-out portion may for a recess. Thus, the beads in the plate and the recess arranged preferably opposite the bead can enter into engagement with one another when the heat exchanger is assembled, in particular when the first and the second collecting tank are connected to the first and the second tubes. In this way, optimum centering can be realized between the plate with the bead and the recess on the cover. In particular, the recess may be arranged on or adjacent to the respective collecting tank wall.

The plate preferably has an encircling region. In this way, after the connection of the respective collecting tank to the plate, a connecting seam can be formed, which is preferably of encircling configuration. After the brazing process, the plate and the first and the second collecting tank are brazed in encircling fashion and form an encircling brazed seam.

The cover is preferably connected to the plate in non-positively locking and positively locking fashion. For example, the cover is brazed to the plate. The connecting technique may also be some other connecting technique that is known per se. For example, the cover and the plate may be welded; in particular, it may then be the case that a weld seam is formed in the region of the bead and of the recess. In this way, a fluid-tight connection can be realized directly between the plate and the respective collecting tank, such that the first coolant circuit and the second coolant circuit are reliably separated, in particular at the interface to the respective plate region. A possible leak in the first and/or the second collecting tank can firstly only pass to the outside. Accordingly, no internal leakage can occur. In particular, connection can form between the first and the second coolant circuit, and coupling of the coolant circuits can be ruled out.

The cover, together with the plate, preferably forms a first inflow duct for the first collecting tank, a first outflow duct for the first collecting tank, and a second duct for the second collecting tank.

Here, the plate may have openings for the first inflow duct, the first outflow duct and the second duct. Here, the second duct may likewise have an inflow duct and a drainage duct. On the first and/or second collecting tank there may be arranged a first inflow connector, a first outflow connector, a second inflow connector and a second outflow connector. The connectors may be connected to the associated ducts.

The plate preferably has openings for the first inflow duct, the first outflow duct, the second inflow duct and/or the second outflow duct.

The plate is preferably connected to the respective collecting tank in a second method step, in particular in a brazing furnace. Here, the brazing between the plate and the respective collecting tank is performed directly, and not merely owing to external brazing of the collecting tank or of parts of the collecting tank, such as is commonly the case in the prior art. Here, it is advantageous that a separation of the first and of the second coolant circuit is possible without a partition, with the necessary cumbersome installation disadvantages, being arranged between the first and the second coolant circuit at the interface between the first and the second collecting tank. It is thus possible for a partition tool to be omitted.

It is preferable for a first and a second heat exchanger to be provided, wherein the first heat exchanger element in the first coolant circuit is a high-temperature cooler. This particularly preferably operates on the basis of the I-flow principle. Here, on the first collecting tank, there may be provided a flange on which there is arranged an net duct through which the coolant can pass into the first tubes. Opposite, on the other enc of the first tubes, there is then preferably arranged a further first collecting tank, on which an outlet duct for the coolant is arranged.

In one refinement, the second heat exchanger element in the second coolant circuit is a low-temperature cooler. The second heat exchanger element with the second coolant circuit may in this case be constructed as a U-flow heat exchanger element. Here, an inlet duct is arranged on the flange and an outlet duct is arranged on the flange on the second collecting tank.

The heat exchanger is in particular an indirect charge-air cooler. In this way, it is possible to realize improved heat transfer between the charge air and the coolant or between the coolant and the ambient air during operation in the low-temperature circuit. This can permit an increase in power of the charge-air cooling.

The low-temperature cooler (iCAC) and the high-temperature cooler (iCAC) may be connected to one another by way of the plate with the brazed-on first and second collecting tanks. The low-temperature cooler and the high-temperature cooler in this case belong to different coolant circuits, in particular to the first coolant circuit and the second coolant circuit. Owing to the brazed bead/punched-out portion connection, the first and the second coolant circuit are reliably separated in terms of flow, and no coupling in terms of flow is possible. Here, the separation is one hundred percent sealed (100% sealed).

In a refinement, the heat exchanger has a partition in the second coolant circuit, which partition is designed to realize a separation of a coolant feed line and of a coolant return line. Here, the partition is preferably connected to the plate and to a wall, situated opposite the plate, of the collecting tank, and said partition separates the feed line and the return line in the second collecting tank. A diversion of the coolant is thus possible.

It is also advantageous for a first heat exchanger element and a second heat exchanger element to be provided, which are arranged adjacent and parallel to one another.

Here, it is expedient if the first heat exchanger element and the second heat exchanger element each have tubes, wherein the tubes of the first and of the second heat exchanger element are arranged parallel to one another.

The object is likewise achieved by way of a motor vehicle having a heat exchanger according to the invention. Here, the heat exchanger is preferably a sequential charge-air cooler which is integrated in the intake pipe and which. has two separate coolant circuits.

Further advantageous embodiments will be described by the following description of the figures and by the subclaims.

### BRIEF DESCRIPTION OF THE FIGURES OF THE DRAWING

Below, the invention will be discussed in more detail, on the basis of at least one exemplary embodiment, with reference to the figures of the drawings, in which:

FIG. 1 shows a first collecting tank having a plate and having tubes of a heat exchanger in an exploded illustration,

FIG. 2 shows the heat exchanger of FIG. 1 in a housing in a perspective illustration,

FIG. 3 shows the heat exchanger in a view of a first collecting tank and a second collecting tank,

FIG. 4 shows the heat exchanger with the first collecting tank and the second collecting tank in a sectional illustration along the longitudinal extent of the first and second tubes,

FIG. 5 shows a photograph of an encircling brazed connection on the first and second collecting tanks.

### PREFERRED EMBODIMENT OF THE INVENTION

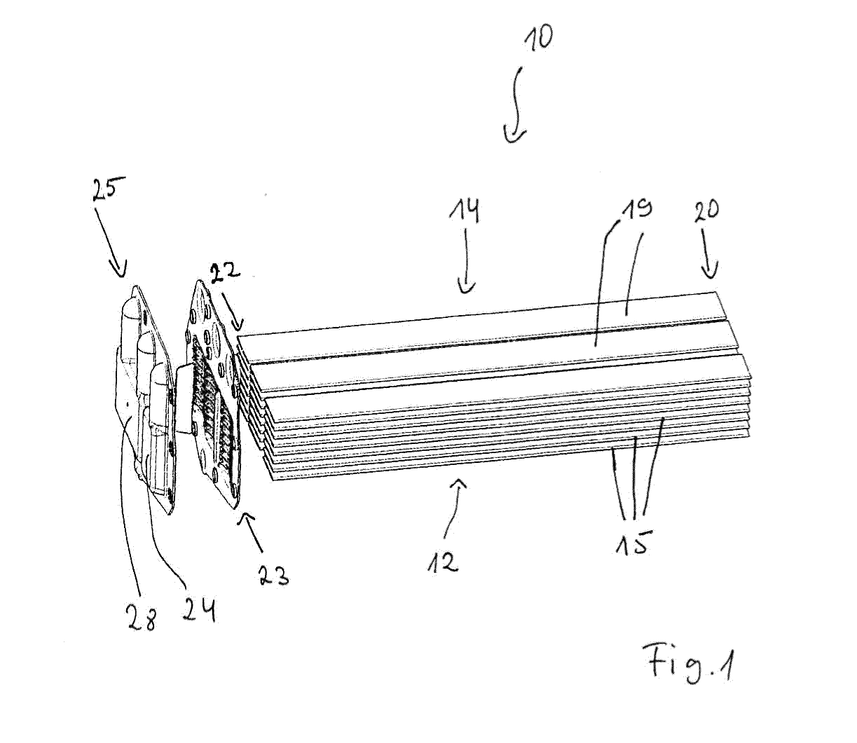

FIG. 1 shows, in an exploded illustration, a heat exchanger 10. In the exemplary embodiment shown, the heat exchanger 10 is a charge-air cooler 10 and may serve for the cooling of charge air for an internal combustion engine of a motor vehicle. In the exemplary embodiment illustrated, the heat exchanger 10 has a first heat exchanger element 12, which is constructed as an I-flow heat exchanger, and a second heat exchanger element 14, which is constructed as a U-flow heat exchanger. The first heat exchanger element 12 is preferably a high-temperature cooler, and the second heat exchanger element 14 is preferably a low-temperature cooler. The first heat exchanger element 12 is part of a first coolant circuit (not illustrated), and the second heat exchanger element is part of a second coolant circuit (not illustrated.). The heat exchanger 10 may in this case be in particular a sequential, indirect charge-air cooler (iCAC) 10.

The indirect charge-air cooler may have two mutually independent, separate coolant circuits. In a multistage, sequential indirect charge-air cooler of said type, the hot charge air is, in one stage, pre-cooled by way of warm coolant, for example from the main cooling circuit of the engine, and, in a second stage situated downstream, is cooled by way of cold coolant from a low-temperature cooler. A known type of construction of a sequential, indirect charge-air cooler is the fin-tube system.

The first coolant circuit with the heat exchanger element 12 and the second coolant circuit with the second heat exchanger element 14 each have a multiplicity of tubes 15, 19, wherein a first coolant can flow through the tubes 15 of the first coolant circuit and a second fluid can flow through the tubes 19 of the second coolant circuit. The tubes 15 and 19 are preferably flat tubes. Here, coolant circuits are preferably independent of one another, and can in particular be operated with different parameters. For example, the coolant of the first coolant circuit and the coolant of the second coolant circuit may be at different pressures. The coolant may be a liquid or a gaseous fluid.

Below, all objects labeled “first” are associated with the first coolant circuit or with the first heat exchanger element 12. Objects labeled “second” are associated with the second coolant circuit or with the second heat exchanger element 14.

The first tubes 15 of the first heat exchanger element 12 are arranged, in a direction of longitudinal extent 16 of the heat exchanger 10, in a housing (not illustrated). The tubes 15, 19 are each arranged, at a first tube end 20 and/or at a second tube end 22, on or in a plate 23, and are fixed in their posit ion by said plate. As viewed in the direction of longitudinal extent 16 of the tubes 15, 19, the plate 23 is arranged between the tubes 15 and a first collecting tank 24 and between the tubes 19 and a second. collecting tank 28, which is arranged adjacent to the first collecting tank 24. The first and the second collecting tank 24 and 28 are preferably each arranged at both ends 20, 22 of the tubes 15, 19. On the first collecting tank 24, at the end. 20, there is arranged a connection duct or outlet duct 26. The first and the second collecting tank 24 and 28 are of substantially trough-like form. The first collecting tank 24 and the second collecting tank 28 together form the cover 25.

The second tubes 19 of the second heat exchanger element 14 are, as viewed in the direction of longitudinal extent 16, arranged substantially parallel to one another and parallel to the first tubes 15 of the first heat exchanger element 12.

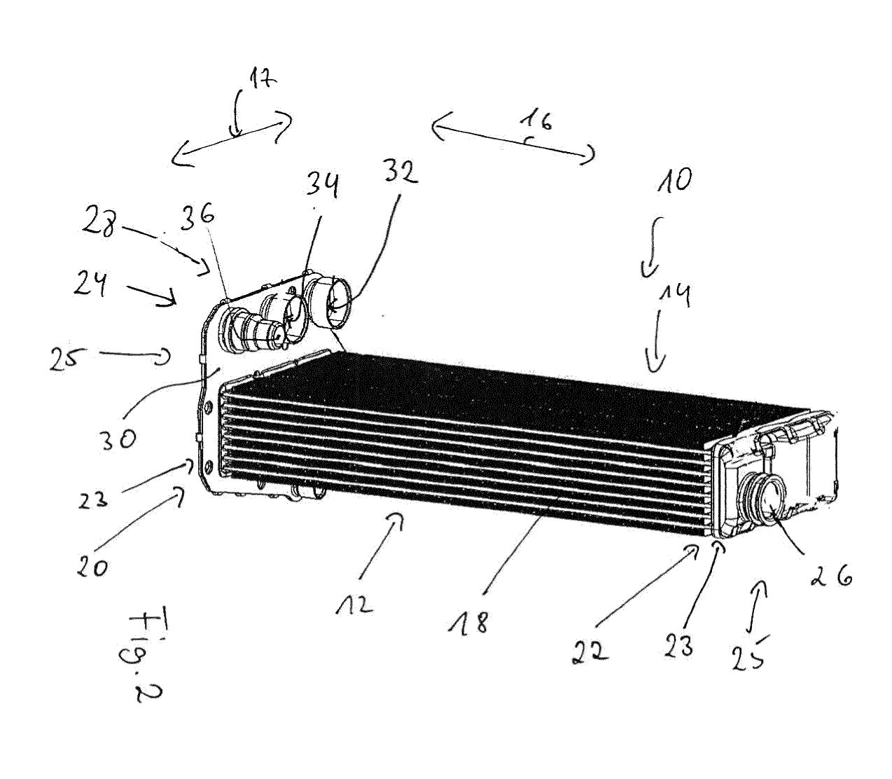

FIG. 2 shows the heat exchanger 10 in a perspective illustration in the assembled state. Identical parts are denoted by the same reference designations.

The tubes 15, 19, in particular flat tubes 15, 19, are optionally arranged in a housing 18, and form the tube-fin block of a fin-tube heat exchanger. The cover 25 has the first collecting tank 24 and the second collecting tank 28 and closes off the housing 18 at least at one of the sides 20, 22. A cover 25 is preferably arranged on each side. On the end 20 of the tubes 15 and 19 there is arranged a flange 30. The plate 23 and the cover 25 may likewise be arranged on the flange 30. The flange 30 preferably has at least one encircling region which projects beyond the in the direction of transverse extent 17 of the tubes 15 and 19. The flange 30 preferably has a region which projects beyond the cover 25.

On the flange 30, there are arranged a first inflow duct 32 and a first outlet duct 34. Also arranged on the flange 30 is a second connection duct 36 which is preferably an inflow duct 36 and which is situated opposite the first connection duct 26, the latter preferably being an outlet duct 26. The inflow duct 32 and the outlet duct 34 are part of the heat exchanger element 14, which is in the form of a U-flow. The duct 26 and the duct 36 are part of the heat exchanger element 12, which is in the form of an I-flow. The plate 23 is arranged between the cover 25, which has the first collecting tank 24 and the second collecting tank 28, and the tubes 15 and 19.

The embodiment of the heat exchanger 10 as a three-part heat exchanger 10 is to be understood merely as an example. The heat exchanger 10 may likewise be a four-part heat exchanger, which has two U-flow heat exchanger elements.

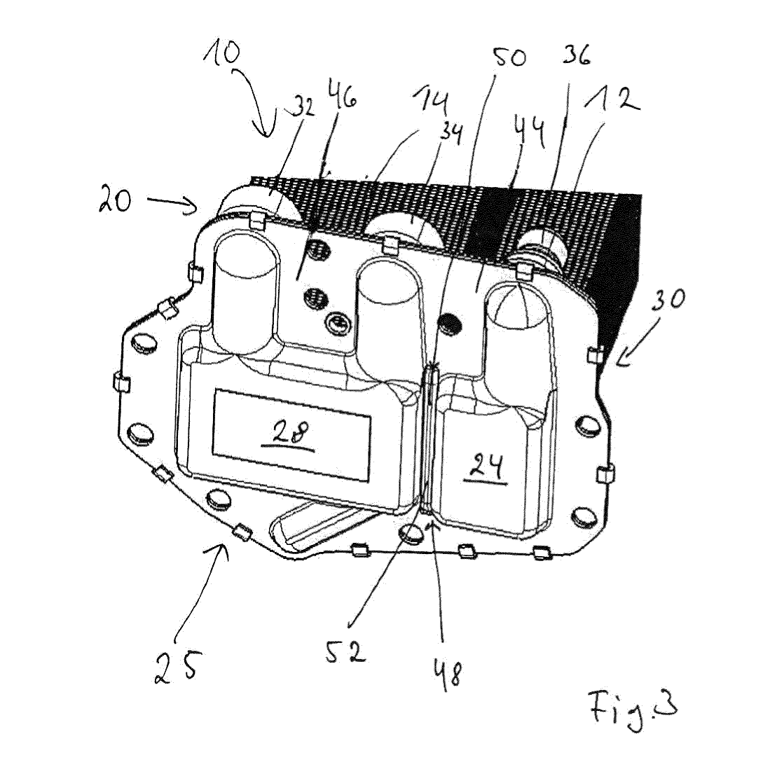

FIG. 3 shows the heat exchanger 10 in a perspective illustration in a viewing direction toward the cover 25, specifically toward the end 20 of the tubes 15 and 19. The plate 23 comprises, in the region of the respective collecting tank 24, 28, the first plate section 44 and the second plate section 46, wherein the first plate section 44 is assigned to the first collecting tank 24 and the second plate section 46 is assigned to the second collecting tank 28.

Between the first plate section 44 and the second. plate section 46, there is arranged a connecting seam 48. The connecting seam. 48 is formed by virtue of a bead 52 engaging into, and being brazed in, a recess 50. The first collecting tank 24 is in this case directly connected in fluid-tight fashion, preferably non-detachable fashion, to the plate 23. The connection between the plate 23 may preferably be realized by way of brazing. Use may however also be made of any other connecting technique known per se, such as for example adhesive bonding or welding, which is suitable for producing a fluid-tight connection, in particular of a bead 52 arranged in the recess 50. In this way, a non-positively locking and positively locking connection is produced between the plate 23 and the cover 25.

A multiplicity of first tubes 15 of the first heat exchanger element 12 is arranged on or in the first plate section 44 and is fixed on or in said first plate section. A multiplicity of second tubes 19 is arranged in the second plate section 46 and is fixed on or in said second plate section. The connecting section 48 or the connecting seam 48 has the punched-out portion 50, formed in the collecting tank and/or in the collecting tank 28, in particular in the cover 25, and has the bead 52 arranged in the plate 23. The bead 52 can enter into engagement, in particular mechanical engagement, with the recess 50 or punched-out portion 50. The punched-out portion/bead pairing can considerably simplify the mounting of the collecting tank 24 on the plate 23, by virtue of the fact that virtually automatic centering is possible. After the connecting process, preferably the brazing process, the punched-out portion/bead connection forms the connecting seam 48, preferably the brazed seam 48.

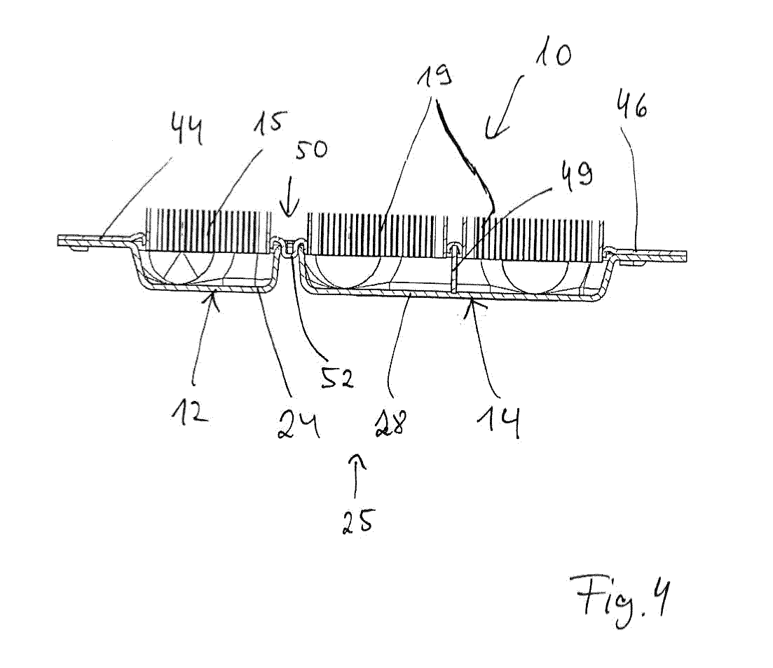

Between the feed line and the return line of the second heat exchanger element 14, there is arranged in the collecting tank 28 a partition 49 which can realize diversion of the coolant flow between coolant feed line and coolant return line. The partition 49 is shown in the sectional illustration of the heat exchanger 10 of FIG. 4.

The first collecting tank 24 and the second collecting tank 28 may be formed as a unipartite component, as the cover 25. The first collecting tank 24 and the second collecting tank 28 may also initially be produced in two parts and connected so as to form the cover 25.

The punched-out portion 50 is configured such that the bead 52 can engage into it.

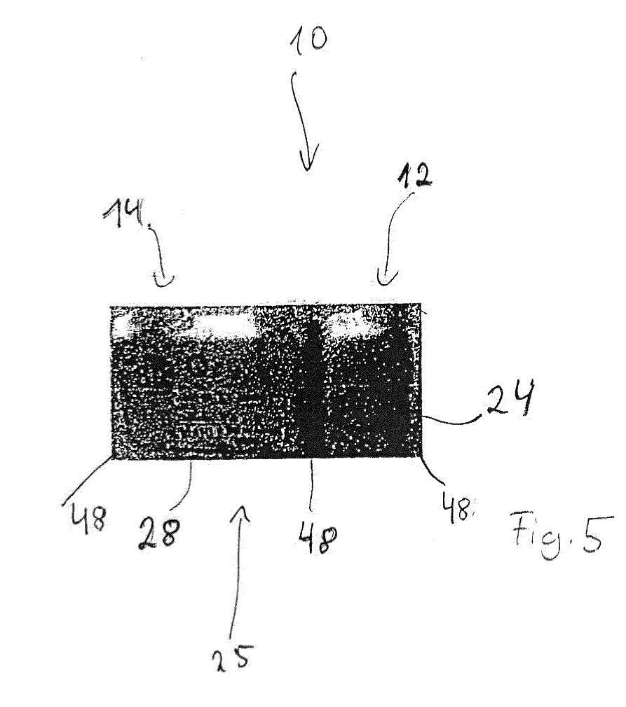

FIG. 5 is an illustration of an assembled and brazed heat exchanger 10 in a plan view of the collecting tanks 24 and 28, that is to say in a frontal view, in the direction of longitudinal extent 16, of the first collecting tank 24 and the second collecting tank 28. It is possible to see the connecting seam 48, which is in the form of a brazed seam 48. The connecting seam 48 is preferably an encircling connecting seam 48 or part of an encircling connecting seam.

1. A heat exchanger, in particular for a motor vehicle, having a first coolant circuit which has multiple first tubes, and having a second coolant circuit which has multiple second tubes, having a plate, wherein the plate has a bead, wherein the plate has a first plate region with openings for receiving the first tubes and a second plate region with openings for receiving the second tubes, having a cover which is connected to the plate, wherein the cover has a first collecting tank and a second collecting tank, wherein the first collecting tank is connected in fluid-tight fashion to the first plate region and the second collecting tank is connected in fluid-tight fashion to the second plate region, wherein the cover has, between the first and the second collecting tank, an opening for receiving the bead.

2. The heat exchanger as claimed in claim 1, wherein the opening is punched out of the cover.

3. The heat exchanger as claimed in claim 1, wherein the plate has an encircling region.

4. The heat exchanger as claimed in claim 1, wherein the cover is connected to the plate in non-positively locking and positively locking fashion.

5. The heat exchanger as claimed in claim 1, wherein the cover, together with the plate, forms a second inflow duct and a second outflow duct for the second collecting tank and a first duct for the first collecting tank.

6. The heat exchanger as claimed in claim 1, wherein the plate has openings for a first inflow duct, the first outflow duct and the inflow and outflow duct.

7. The heat exchanger as claimed in claim 1, wherein the heat exchanger is an indirect charge-air cooler for the cooling of charge air.

8. The heat exchanger as claimed in claim 1, wherein a first heat exchanger element and a second heat exchanger element are provided, which are arranged adjacent and parallel to one another.

9. The heat exchanger as claimed in claim 1, wherein the first heat exchanger element and the second heat exchanger element each have tubes, wherein the tubes of the first and of the second heat exchanger element are arranged parallel to one another.

10. A motor vehicle having a heat exchanger, in particular a charge-air cooler, as claimed in claim 1.
